(19) United States
(12) Patent Application Publication
(10) Pub. No.: US 2024/0056459 A1
(43) Pub. Date: Feb. 15, 2024

(54) STREAM EXTRACTION ADMINISTRATION SYSTEM

(71) Applicant: Recorded Future, Inc., Somerville, MA (US)

(72) Inventors: Simon Westlund, Gothenburg (SE); Josefin Scott, Gothenburg (SE); Melina Andersson, Gothenburg (SE); Mia Nordström, Gothenburg (SE); Mathias Wingård, Gothenburg (SE)

(21) Appl. No.: 18/234,256

(22) Filed: Aug. 15, 2023

Related U.S. Application Data
(60) Provisional application No. 63/397,970, filed on Aug. 15, 2022.

(51) Int. Cl. H04L 9/40

(52) U.S. Cl. CPC H04L 63/1416

(57) ABSTRACT

In one general aspect, a computer network security threat monitoring method for a processor and a storage device including instructions configured to run on the processor is disclosed. The method includes continuously gathering machine-readable documents from one or more streams of third-party machine-readable documents from network sources selected based on predetermined selection criteria, evaluating machine-readable documents gathered from the streams according to one or more productivity rejection criteria and rejecting machine-readable documents that meet the productivity rejection criteria, and processing the gathered machine-readable documents to extract threat information about conditions on the network except if they meet the one or more productivity rejection criteria.

### FIELD OF THE INVENTION

This invention relates to methods and apparatus for extracting information from unpredictable data streams including methods and apparatus that are configured to determine the dispensability of instances of documents that are likely to be unproductive relative to the nature of the information to be extracted.

### BACKGROUND OF THE INVENTION

Data retrieved from third-party sources on a network such as the Internet can be helpful in evaluating and predicting conditions on the network, such as security and cyber security threats. One powerful system for extraction of threat information is the Recorded Future Temporal Analytics Engine, which is described in more detail in U.S. Pat. No. 8,468,153 entitled INFORMATION SERVICE FOR FACTS EXTRACTED FROM DIFFERING SOURCES ON A WIDE AREA NETWORK, in U.S. Publication No. 20180063170 entitled NETWORK SECURITY SCORING, in published PCT application No. WO2020154421 entitled AUTOMATED ORGANIZATIONAL SECURITY SCORING SYSTEM, and in PCT Patent Application No. PCT/US20/23451 entitled CROSS-NETWORK SECURITY EVALUATION. These documents are all herein incorporated by reference.

This system continuously extracts information on a variety of topics from many different sources, including paid sources and textual information posted on parts of the Internet, such as on the web and in social media. It can then process and rank this extracted information to detect possible security and cyber security threats. One powerful technique to identify threats is to correlate co-occurring information extracted from different sources to detect coordinated events, patterns, and trends.

### SUMMARY OF THE INVENTION

In one general aspect, the invention features a computer network security threat monitoring method for a processor and a storage device including instructions configured to run on the processor. The method includes continuously gathering machine-readable documents from one or more streams of third-party machine-readable documents from network sources selected based on predetermined selection criteria, evaluating machine-readable documents gathered from the streams according to one or more productivity rejection criteria and rejecting machine-readable documents that meet the productivity rejection criteria, and processing the gathered machine-readable documents to extract threat information about conditions on the network except if they meet the one or more productivity rejection criteria.

In preferred embodiments the method can further include evaluating machine-readable documents gathered from the streams according to one or more productivity acceptance criteria with the processing the gathered machine-readable documents processing all of the gathered machine-readable documents that satisfy the acceptance criteria to extract threat information. The method can further include queuing at least some of the documents that do not satisfy the rejection criteria for manual review. The method can further include adjusting at least some of the rejection criteria based on results of the manual review. The method can further include confirming at least some of the rejection criteria based on results of the manual review. The evaluating documents according to rejection criteria can apply a plurality of heuristics, such as probabilistic heuristics. The application of probabilistic heuristics can include calculating a distance between a feature representation of a stream of machine-readable documents and identified clusters previously learned by a probabilistic model. The evaluating documents according to rejection criteria can apply deterministic heuristics. The evaluating documents according to rejection criteria can apply a dispensability score to the documents. The evaluating documents according to rejection criteria can apply a dispensability score to the documents based on URLs of the documents. The evaluating documents according to rejection criteria can apply a dispensability score to the documents based on the presence in the URL of one or more weighted indicator expressions. The evaluating documents according to rejection criteria can apply a dispensability score to the documents based on a ratio of valuable entities to total token value. The evaluating documents according to rejection criteria can apply a dispensability score to the documents based on a relationship between true content size and compressed size. The application of heuristics can include utilizing one or more foundation models to reprocess items in a stream of machine readable documents. The application of heuristics can include utilizing one or more Large Language Models (LLMs) to reprocess items in a stream of machine readable documents. The application of heuristics can include utilizing one or more foundation models to gain more information about or summarize items in a stream of machine readable documents. The continuously gathering and evaluating machine-readable documents can operate on a plurality of formats including textual, image, video, and pdf formatted machine-readable documents.

In another general aspect, the invention features a computer network security threat monitoring system. The system includes a document analyzer to extract and resolve named entities in an unpredictable data stream, a dispensability assessor responsive to the document analyzer and operative to apply heuristics utilizing the named entities in the data stream and thereby determine the document's dispensability, and a dispensability service responsive to the dispensability assessor to receive and store the documents that are determined to be dispensable by the dispensability assessor. In preferred embodiments, the system can further include a user interface responsive to the dispensability service and operative to allow a user to inspect the documents that are determined to be dispensable by the dispensability assessor.

In a further general aspect, the invention features a computer network security threat monitoring system. The system includes means for continuously gathering machine-readable documents from one or more streams of third-party machine-readable documents from network sources, means for evaluating gathered machine-readable documents from the streams according to one or more productivity acceptance criteria and accepting machine-readable documents that meet the productivity acceptance criteria, means for evaluating gathered machine-readable documents from the streams according to one or more productivity rejection criteria and rejecting machine-readable documents that meet the productivity rejection criteria, and means for processing the gathered machine-readable documents that satisfy the acceptance criteria and do not satisfy the rejection criteria to extract threat information about conditions on the network.

Systems according to the invention can help to thoroughly search data streams for threat information by actively rejecting at least some documents deemed unproductive in the stream. This can improve the collection of useful information acquired in detecting conditions on a network even though some documents are not processed. The improved collection can be particularly important in detecting threat information on a large network where one may be looking for a potentially very important threat pattern in a vast amount of data.

### BRIEF DESCRIPTION OF THE DRAWING

FIG. 1 is a block diagram of a document stream administration system according to the invention; and

FIG. 2 is a sequence diagram illustrating operation of the system of FIG. 1.

### DETAILED DESCRIPTION OF AN ILLUSTRATIVE EMBODIMENT

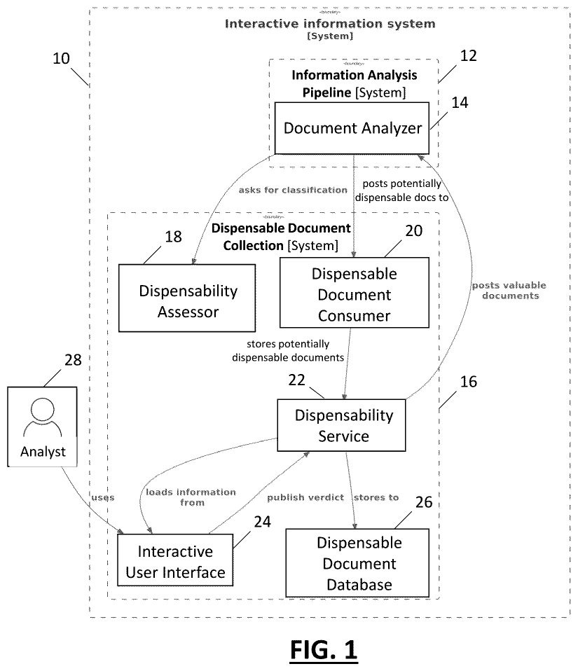

Referring to FIG. 1, an illustrative document stream administration system 10 according to the invention operates to detect unproductive (or dispensable) instances of data on a stream of information documents containing an unpredictable variety of input coming from machine-readable information sources where unproductive instances of data are document instances that are collected by the system but never found valuable by the system's users. A detection process operates on a continuous stream of information and determines the dispensability of the instances to then transfer the dispensable occurrences for additional storage and manual expert status assessment in the interactive interface which is populated by the stream extraction administration system storage. The characteristics of the instances of data coming from the stream of information are propagated through a combination of deterministic and/or probabilistic heuristics based on perceptive insights and component-based inference to determine the dispensability of the instance feed. This can enable an aggressive collection strategy while keeping the system resilient to overload from unproductive data.

Referring to FIG. 1, a document stream administration system 10 according to the invention includes an information analysis pipeline system 12 and a dispensable document collection system 16. The information analysis pipeline system receives selected data received or harvested from one or more data sources, such as news feeds, web data, and social media data by an adapter according to appropriate selection criteria. The selection criteria can take a variety of forms, such as subscription parameters, queries, or filters, as described in the above-referenced patent documents.

The document stream administration system 10 also includes a document analyzer 14, which is a sub-system that operates on the stream of information documents and extracts and resolves named entities within the document instances. The document analyzer performs other types of analysis as well, such as language detection, event extraction and sentiment analysis. The document analyzer can be designed to process multiple different types of documents in any format including, but not limited to, textual, image, video, and pdf formatted machine-readable documents.

The dispensable document collection system 16 includes a dispensability assessor 18. This component is responsible for applying heuristics on a continuous stream of information coming from the document analyzer and determines the dispensability of the instances (if the document can be classified as dispensable or not). The dispensable document collection system 16 also includes a dispensable document consumer 20, which is a component responsible for handling incoming dispensable instances from the document analyzer 14 and storing them to a database via the dispensability service. The dispensability service 22 is a backend service to handle storage of unproductive instances as well as assessments and statuses of them. The dispensable document collection system further includes a dispensable document database 26 for storing original messages and information about the unproductive instances as well as assessments and statuses of them.

The dispensability assessor is designed to apply heuristics to determine the dispensability of the instances. These heuristics could be based on information about the context and metadata of the document such as document origin, publication time and/or information about the publisher of the document as well as information from other documents from a similar context. The heuristics could also be based on the content of the document such as grammatical discrepancies, lack of prose and/or tabular indicators. Some examples include:

1. The presence of weighted indicator expressions with the capability to mitigate and/or enhance the probability of the instance dispensability. If the weights and indicators are modeled as tuples of strings and multidimensional numerical vectors vi determined by cooccurrences of indicators previously omitted by the manual expert status assessment in the interactive interface, then, given the title and the originating URL of a previously unseen document instance, the dispensability assessor 18 can combine the set of pairs determined by cooccurrences of indicators previously omitted to compute a dispensability score of the instance which then contributes to the final verdict made by the system.

In one embodiment, the system looks for strings in the document's URL indicating that a document may be less useful, with corresponding weights to the indicators. Here is a version of a list:

[(“annual_report”, v₁),
(“/manual/”, v₂),
(“investor_relations”, v₃),
(“/budget/”, v₄),
(“/statistics/”, v₅),
. . . ,
(“technical-documentation”, vₙ)]

where vi refers to the corresponding multidimensional numerical vector.

2. The ratio of valuable entities against the total token volume within the instance with the capability to mitigate and/or enhance the probability of the instance dispensability. A sub-system can operate on a stream of information documents and extract and resolve named entities within the document instances. The dispensability assessor 18 can then calculate a ratio of valuable named entities against a total number of tokens within the document content and utilize this as a dispensability score of the instance which then contributes to the final verdict made by the system.

3. The quantitative relationship between the true content size and a compressed version of the document content with the capability to mitigate and/or enhance the probability of the instance dispensability. If a feed of a subset of the information documents exists where one can compute true content size, then, given the actual document content one can apply a lossy compression algorithm and calculate the quantitative relationship between the true content size of the document content and the size of the result from the lossy compression algorithm and utilize this as a dispensability score of the instance which then contributes to the final verdict made by the system.

4. A probabilistic model utilizing the previously assessed instances marked as valuable or dispensable with the capability to mitigate and/or enhance the probability of the instance dispensability. A sub-system can operate on batches of information documents and learn the feature representation of dispensable document instances. The dispensability assessor 18 can then calculate the distance between the feature representation of a stream of instance documents and the identified clusters previously learned by the probabilistic model and utilize this as a dispensability score of the instance which then contributes to the final verdict made by the system.

5. Trained models, including foundation models, such as Large Language Models (LLMs) can also be used to reprocess items in a stream of machine readable documents. They can be used, for example, to gain more information about or summarize items in a stream of machine readable documents.

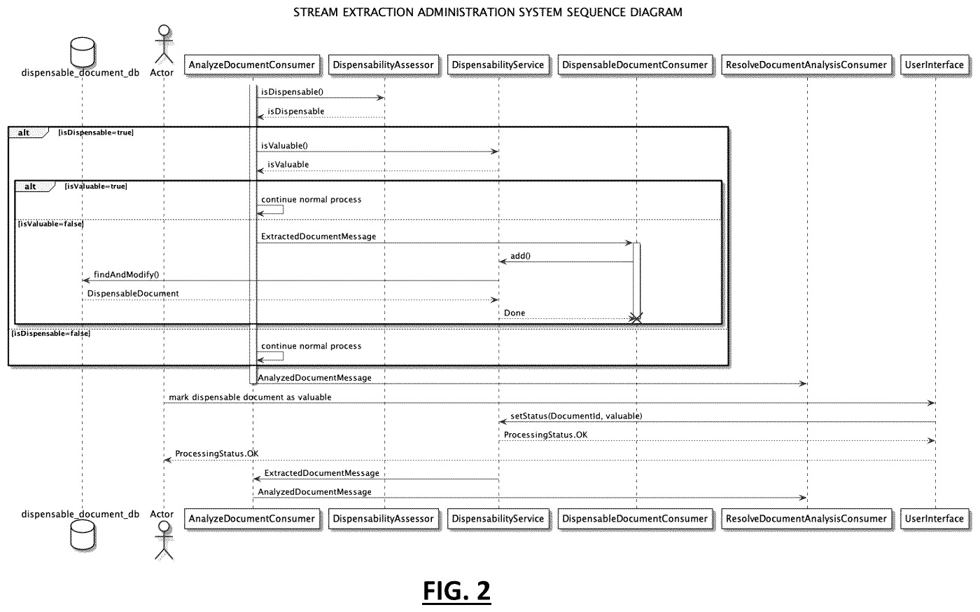

Referring also to FIG. 2, the system 10 operates as follows:

1. A document enters the document analyzer 14 and is eligible for analysis as unproductive data (dispensable).

2. The document analyzer 14 calls the dispensability assessor 18 to get an assessment on whether the document is potentially unproductive. The dispensability assessor uses heuristics such as the ones described above to determine whether that is the case or not and returns the automated verdict.

a. If the document is deemed unproductive, the dispensable document collection is enabled for the source and the document has not previously been marked as valuable by an expert (actor), the document analyzer 14 will post a message (ExtractedDocumentMessage) to the dispensable collection consumer 20 and acknowledge the original message posted to it. This means that the regular processing and analysis flow of the document is stopped and put on hold. The effect of this will be that the original document storage is updated with information about why the processing ended.

b. If the document has previously been marked as valuable, the regular processing will continue without any effect.

c. If the document is not deemed as unproductive or the dispensable document collection is not enabled for the source, the regular processing will continue without any effect.

3. All dispensable documents that have been collected are stored in a dispensable document database.

### Manual Assessment

The interactive user interface 24 can be used to access information about what documents have been collected and metadata around it by using the dispensability service 22 and the database. Given this information an expert can use the interface to mark documents as valuable if they for some reason have not been correctly assessed by the dispensability assessor 18, or confirm that they are unproductive if they have been correctly assessed by the dispensability assessor 18.
If the document is marked as valuable, the ExtractedDocumentMessage will be reposted to the document analyzer 14 for regular processing and storage (including its index). Furthermore, the information about the document will be used to enhance the heuristics further improving the algorithm.
If the document is marked as dispensable, nothing will happen, the document is stopped from further analysis and storage. Additionally, the information about the document will be used to enhance the heuristics, further improving the algorithm.
If the document is not marked at all, nothing will happen but the document remains paused from further analysis and storage.
If the expert changes his or her mind, it is possible to change the verdict of a document to affect the algorithm. If the verdict is changed from dispensable to valuable the document will be reposted for analysis. If the verdict is changed from valuable to dispensable the document is removed from the regular storage (including its index).

The system described above has been implemented in connection with digital logic, storage, and other elements embodied in special-purpose software running on a general-purpose computer platform, but it could also be implemented in whole or in part using virtualized platforms and/or special-purpose hardware. And while the system can be broken into the series of modules and steps shown in the various figures for illustration purposes, one of ordinary skill in the art would recognize that it is also possible to combine them and/or split them differently to achieve a different breakdown.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A computer network security threat monitoring method for a processor and a storage device including instructions configured to run on the processor, including:
continuously gathering machine-readable documents from one or more streams of third-party machine-readable documents from network sources selected based on predetermined selection criteria,
evaluating machine-readable documents gathered from the streams according to one or more productivity rejection criteria and rejecting machine-readable documents that meet the productivity rejection criteria, and
processing the gathered machine-readable documents to extract threat information about conditions on the network except if they meet the one or more productivity rejection criteria.

2. The method of claim 1 further including evaluating machine-readable documents gathered from the streams according to one or more productivity acceptance criteria and wherein the processing the gathered machine-readable documents processes all of the gathered machine-readable documents that satisfy the acceptance criteria to extract threat information.

3. The method of claim 1 further including queuing at least some of the documents that do not satisfy the rejection criteria for manual review.

4. The method of claim 3 further including adjusting at least some of the rejection criteria based on results of the manual review.

5. The method of claim 4 further including confirming at least some of the rejection criteria based on results of the manual review.

6. The method of claim 1 wherein the evaluating documents according to rejection criteria applies a plurality of heuristics.

7. The method of claim 6 wherein the evaluating documents according to rejection criteria applies probabilistic heuristics.

8. The method of claim 6 wherein the application of probabilistic heuristics includes calculating a distance between a feature representation of a stream of machine-readable documents and identified clusters previously learned by a probabilistic model.

9. The method of claim 6 wherein the evaluating documents according to rejection criteria applies deterministic heuristics.

10. The method of claim 6 wherein the evaluating documents according to rejection criteria applies a dispensability score to the documents.

11. The method of claim 6 wherein the evaluating documents according to rejection criteria applies a dispensability score to the documents based on URLs of the documents.

12. The method of claim 6 wherein the evaluating documents according to rejection criteria applies a dispensability score to the documents based on the presence in the URL of one or more weighted indicator expressions.

13. The method of claim 6 wherein the evaluating documents according to rejection criteria applies a dispensability score to the documents based on a ratio of valuable entities to total token value.

14. The method of claim 6 wherein the evaluating documents according to rejection criteria applies a dispensability score to the documents based on a relationship between true content size and compressed size.

15. The method of claim 6 wherein the application of heuristics includes utilizing one or more foundation models to reprocess items in a stream of machine readable documents.

16. The method of claim 15 wherein the application of heuristics includes utilizing one or more Large Language Models (LLMs) to reprocess items in a stream of machine readable documents.

17. The method of claim 15 wherein the application of heuristics includes utilizing one or more foundation models to gain more information about or summarize items in a stream of machine readable documents.

18. The method of claim 1 wherein the continuously gathering and evaluating machine-readable documents operate on a plurality of formats including textual, image, video, and pdf formatted machine-readable documents.

19. A computer network security threat monitoring system, including:
a document analyzer to extract and resolve named entities in an unpredictable data stream,
a dispensability assessor responsive to the document analyzer and operative to apply heuristics utilizing the named entities in the data stream and thereby determine the document's dispensability, and
a dispensability service responsive to the dispensability assessor to receive and store the documents that are determined to be dispensable by the dispensability assessor.

20. The system of claim 19 further including a user interface responsive to the dispensability service and operative to allow a user to inspect the documents that are determined to be dispensable by the dispensability assessor.

21. A computer network security threat monitoring system, including:
means for continuously gathering machine-readable documents from one or more streams of third-party machine-readable documents from network sources,
means for evaluating gathered machine-readable documents from the streams according to one or more productivity acceptance criteria and accepting machine-readable documents that meet the productivity acceptance criteria,
means for evaluating gathered machine-readable documents from the streams according to one or more productivity rejection criteria and rejecting machine-readable documents that meet the productivity rejection criteria, and
means for processing the gathered machine-readable documents that satisfy the acceptance criteria and do not satisfy the rejection criteria to extract threat information about conditions on the network.
